(19) United States
(12) Patent Application Publication
(10) Pub. No.: US 2014/0319396 A1
(43) Pub. Date: Oct. 30, 2014

(54) VALVE

(71) Applicant: HON HAI PRECISION INDUSTRY CO., LTD., New Taipei (TW)

(72) Inventor: CHIH-HAO CHU, New Taipei (TW)

(73) Assignee: HON HAI PRECISION INDUSTRY CO., LTD., New Taipei (TW)

(21) Appl. No.: 14/135,405

(22) Filed: Dec. 19, 2013

(30) Foreign Application Priority Data
Apr. 24, 2013 (TW) 102114580

(51) Int. Cl. F16K 31/56

(52) U.S. Cl. CPC F16K 31/566
USPC 251/213

(57) ABSTRACT

A valve includes a main body, an actuating member, and at least one resilient member. The main body defining includes a sliding hole and comprising a first connecting hole, a second connecting hole and a third connecting hole. The first connecting hole and the second connecting hole communicate with the sliding hole. The actuating member includes a sliding rod interferentially fit and slidable received in the sliding hole between a first position and a second position. The sliding rod defines a first hole, a second hole, and a third hole communicating with the second hole. Opposite ends of the at least one resilient member are connected to the main body and the actuating member for maintaining the actuating member in the first position

### BACKGROUND

1. Technical Field

The present disclosure relates to a valve with a simple structure.

2. Description of Related Art

Valves are used to direct flow of water, gas, and other materials. However, a structure of the valves is often complex, and it is often difficult to fix or maintain the valves if they malfunction or break. Thus, a new type of valve with a simple structure is required.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled, isometric view of an exemplary embodiment of a valve with an actuating member in a first position.

FIG. 2 is an exploded, isometric view of the valve of FIG. 1.

FIG. 3 is a cross-sectional view of the valve of FIG. 1 taken along line III-III.

FIG. 4 is similar to FIG. 1, but shows the actuating member in a second position.

FIG. 5 is a cross-sectional view of the valve of FIG. 4 taken along line IV-IV.

### DETAILED DESCRIPTION

Embodiments of the present disclosure will now be described in detail, with reference to the accompanying drawings.

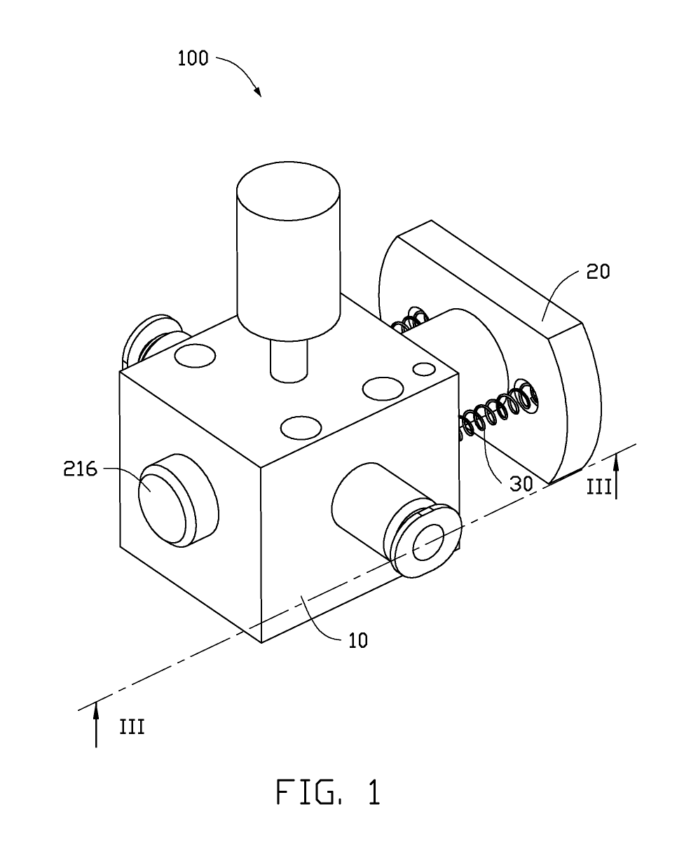

FIG. 1 illustrates an isometric view of an exemplary embodiment of a valve 100. The valve 100 comprises a main body 10, an actuating member 20, and two resilient members 30. The actuating member 20 is slidably connected to the main body 10. Opposite ends of the resilient member 30 is respectively attached to the main body 10 and the actuating member 20. In the embodiment, the resilient members 30 are both coiled springs.

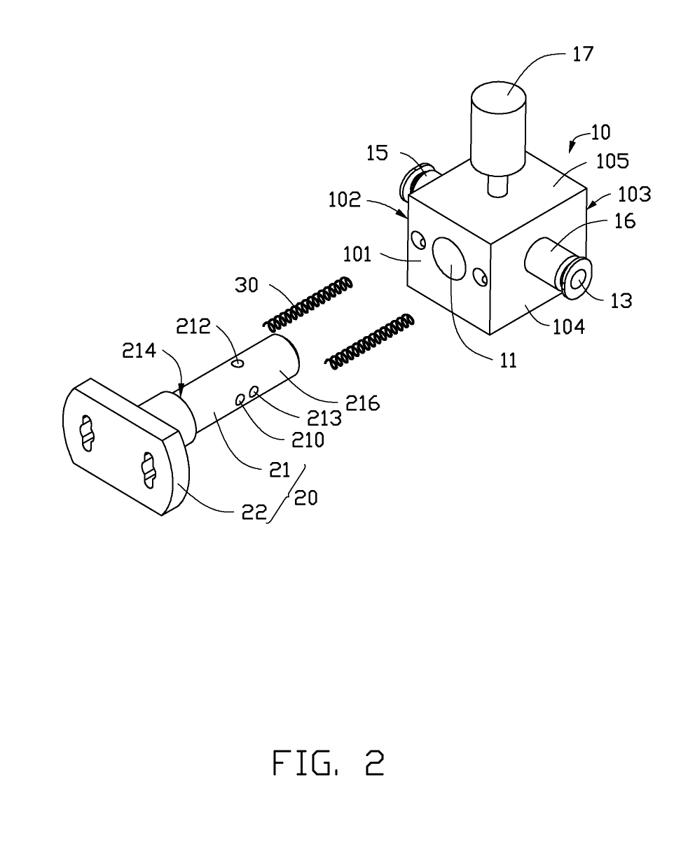

Referring also to FIGS. 2-5, the main body 10 comprises a first side surface 101, a second side surface 102, a third side surface 103, a fourth side surface 104, and a top surface 105. The first side surface 101 is substantially parallel to the third side surface 103. The second side surface 102 is substantially parallel to the fourth side surface 104. The main body 10 comprises a first joint 15 and a second joint 16. The first joint 15 protrudes from the second side surface 102, and the second joint 16 protrudes from the fourth side surface 104. A first connecting hole 12 is defined in the first joint 15. A second connecting hole 13 is defined in the second joint 16. A third connecting hole 14 is defined in the top surface 105. The first connecting hole 12, the second connecting hole 13, and the third connecting hole 14 communicate with the sliding hole 11. The main body 10 comprises a first joint 15 protruding from the second side surface 102, a second joint 16 protruding from the fourth side surface 104, and a muffler 17 partly received in the third connecting hole 14. The first joint 15 and the second joint 16 are used to connect with pipes. In the embodiment, the first connecting hole 12 is substantially aligned with the second connecting hole 13.

The actuating member 20 comprises a sliding rod 21 and a fixing plate 22 connected to one end of the sliding rod 21. The sliding rod 21 defines a first hole 210, a second hole 212, and a third hole 213 communicating with the second hole 212. Opposite ends of the first hole 210 correspond to the first connecting hole 12 and the second connecting hole 13. The second hole 212 corresponds to the third connecting hole 14, and the third hole 214 corresponds to a portion of the second connecting hole 13 in the second joint 16. The sliding rod 21 comprises a shoulder 214 and a distal end portion 216 away from the fixing plate 22. The sliding rod 21 is interferentially fit and slidably received in the sliding hole 11 of the main body 10.

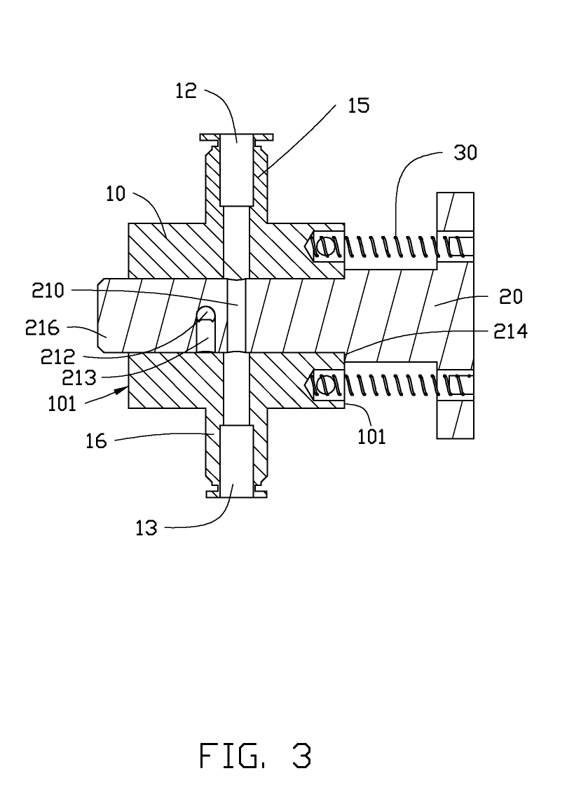

Referring again to FIGS. 1 and 3, in a first position, the sliding rod 21 of the actuating member 20 is received through the first sliding hole 11, and the distal end portion 216 protrudes from the third side surface 103. The shoulder 214 abuts against the first side surface 101 of the main body 10. Opposite ends of the first hole 210 are respectively substantially aligned with the first connecting hole 12 and the second connecting hole 13. Thus, the second connecting hole 13 communicates with the first connecting hole 12 and does not communicate with the third connecting hole 14. In the first position, liquid may flow between the first connecting hole 12 and the second connecting hole 13 through the first hole 210.

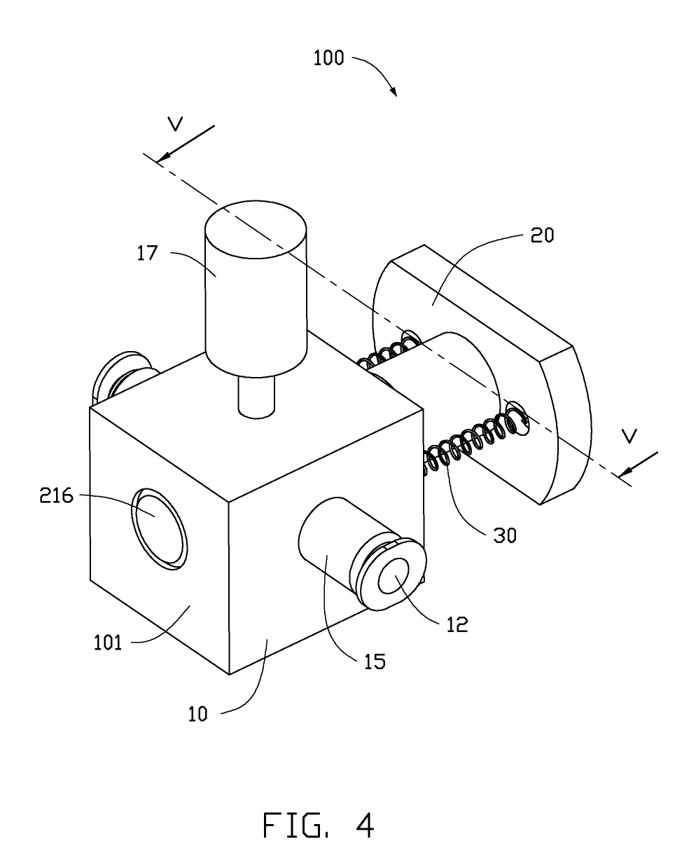

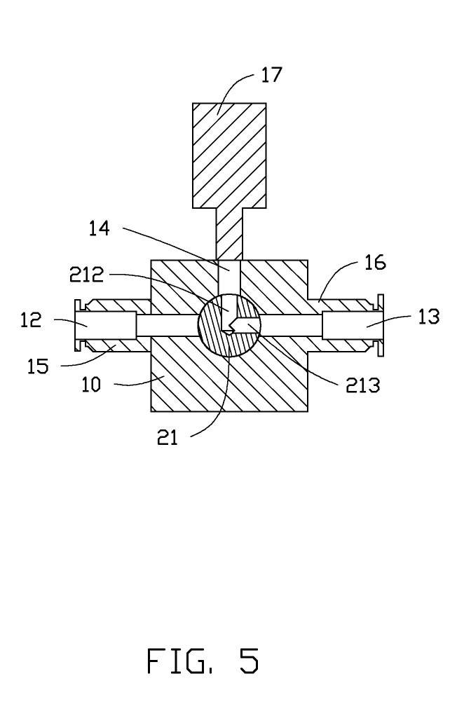

Referring to FIGS. 4 and 5, when the distal end portion 216 is pushed into the sliding hole 11 to be substantially coplanar with the first side surface 101, the actuating member 20 is in a second position, thereby elastically deforming the resilient members 30. In the second position, the second hole 212 is substantially aligned with the second connecting hole, and the third hole 213 is substantially aligned with the third connecting hole 14. Thus, the second connecting hole 13 communicates with the third connecting hole 14 and does not communicate with the first connecting hole 12. In the second position, liquid may flow between the second connecting hole 13 and the third connecting hole 14 through the second hole 212. The resilient members 30 elastically restore when the distal end portion 216 ceases being pushed and drive the actuating member 20 to return to the first position.

While various embodiments have been described and illustrated, the disclosure is not to be construed as being limited thereto. Various modifications can be made to the embodiments by those skilled in the art without departing from the true spirit and scope of the disclosure.

What is claimed is:

1. A valve comprising:
a main body defining comprising a sliding hole and comprising a first connecting hole, a second connecting hole and a third connecting hole, the first connecting hole and the second connecting hole communicating with the sliding hole;
an actuating member comprising a sliding rod interferentially fit and slidable received in the sliding hole between a first position and a second position, the sliding rod defining a first hole, a second hole, and a third hole communicating with the second hole; and
at least one resilient member with opposite ends connected to the main body and the actuating member for maintaining the actuating member in the first position, wherein:
when the sliding rod is in the first position, the first hole is substantially aligned with the first connecting hole and the second connecting hole, and the first connecting hole and the second connecting hole communicate with each other for allowing liquid to flow therebetween;
when the sliding rod is in the second position, the second hole is substantially aligned with the third connecting hole, the third hole is substantially aligned with the second connecting hole, and the second connecting hole and the third connecting hole communicate with each other for allowing liquid to flow therebetween.

2. The valve as described in claim 1, wherein the main body comprises a first joint protruding therefrom for connection to a pipe, the first connecting hole extending through the first joint.

3. The valve as described in claim 1, wherein the main body comprises a second joint protruding therefrom for connection to a pipe, the second connecting hole extending through the first joint.

4. The valve as described in claim 1, wherein the actuating member further comprises a fixing plate connected to one end of the sliding rod, the sliding rod is slidably received in the sliding hole, and one end of the at least one resilient member is attached to the fixing plate.

5. The valve as described in claim 4, wherein the sliding rod comprises a shoulder, and when the actuating member is in the first position, the shoulder abuts against the main body.

6. The valve as described in claim 4, wherein the sliding rod comprises a distal end portion away from the fixing plate, when the actuating member is in the first position, the distal end portion sticks out of the sliding hole, and when the actuating member is in the second position, the distal end portion is substantially coplanar with an outer surface of the main body.

7. The valve as described in claim 1, wherein the main body further comprises a muffler partly received in the third connecting hole.

8. The valve as described in claim 1, wherein the at least one resilient member is a coiled spring.
